(19) United States
(12) Patent Application Publication
(10) Pub. No.: US 2014/0282191 A1
(43) Pub. Date: Sep. 18, 2014

(54) DYNAMIC NAVIGATION OF RANGES IN CALENDAR VIEWS

(71) Applicant: Microsoft Corporation, Redmond, WA (US)

(72) Inventors: Jason A. Cook, Renton, WA (US); Sangya Singh, Bellevue, WA (US); Karl-Erik Bystrom, Bellevue, WA (US); Joseph P. McLaughlin, Seattle, WA (US); Jonathan David Friedman, Seattle, WA (US); Christina Ryan Ergonis, Bellevue, WA (US); Tor-Helge Persett, Seattle, WA (US)

(21) Appl. No.: 13/915,699

(22) Filed: Jun. 12, 2013

Related U.S. Application Data
(60) Provisional application No. 61/777,063, filed on Mar. 12, 2013.

(51) Int. Cl. G06F 3/0484

(52) U.S. Cl. CPC G06F 3/0484
USPC 715/771

(57) ABSTRACT

Systems, methods, and software are disclosed herein for facilitating enhanced calendar views. In an implementation, an initial range in a series of calendar units is presented in a calendar view. An initial calendar perspective associated with an initial position established within the initial range is also presented. Responsive to a user input, a navigation effect is presented with respect to the series of calendar units comprising navigating from the initial range to a subsequent range in the series of calendar units. A subsequent perspective associated with a subsequent position established within the subsequent range is then presented

### RELATED APPLICATIONS

This application claims the benefit of and priority to U.S. Provisional Application No. 61/777,063 filed on Mar. 12, 2013, and entitled DYNAMIC NAVIGATION OF RANGES IN CALENDAR VIEWS, which is hereby incorporated by reference in its entirety.

### TECHNICAL FIELD

Aspects of the disclosure are related to computing hardware and software technology, and in particular to information management applications.

### TECHNICAL BACKGROUND

Information management applications provide users with effective and convenient ways to communicate with others and manage their information. Examples of information management applications include but are not limited to email applications and calendar applications. Some information management applications integrate these various types of applications by way of modules, such as email, calendar, contact, and task modules, although each type of application or functionality may also be provided in a stand-alone manner. Microsoft® Outlook® is one example of an information management application.

While many information management applications are provided as locally installed and executed applications, many can be experienced in a wide variety of ways. For example, some information management applications are available as web-based applications that are experienced through a browser application, as mobile applications customized for mobile environment, or even as a mobile web-based application generally developed for a mobile browser experience. In addition, information management applications can be experienced on a wide variety of computing devices, such as desktop, laptop, or tablet computers, mobile phones, gaming systems, Internet appliances, or any other physical or virtual computing system, variation, or combination thereof.

In a typical calendar application or module, a variety of perspectives on a calendar can be viewed. For example, a monthly perspective, a weekly perspective a work-week perspective, or a daily perspective may be selected and viewed. The selected perspective typically encompasses a dominant portion of a calendar view.

Various tools may be present within a calendar view to assist the user with navigating within a calendar or to other modules that may be present within an information management application. One tool allows a user to navigate on a per-month basis backward or forward in time. As a user clicks on a backward or forward graphic, the tool is navigated through each preceding or succeeding month. In addition, the date range presented within a given perspective changes in accordance with the navigation.

### OVERVIEW

Provided herein are systems, methods, and software for facilitating enhanced calendar views. In an implementation, an initial range in a series of calendar units is presented in a calendar view. An initial calendar perspective associated with an initial position established within the initial range is also presented. Responsive to a user input, a navigation effect is presented with respect to the series of calendar units comprising navigating from the initial range to a subsequent range in the series of calendar units. A subsequent perspective associated with a subsequent position established within the subsequent range is then presented.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational scenario associated with an information management application in an implementation.

FIG. 2 illustrates an enhanced view process in an implementation.

FIG. 3 illustrates a computing architecture in an implementation.

FIG. 4 illustrates a communication environment in an implementation.

FIG. 5 illustrates various scenarios involving a view of an information management application in various implementations.

FIG. 6 illustrates various scenarios involving a view of an information management application in various implementations.

FIG. 7 illustrates a scenario involving a view of an information management application in an implementation.

FIG. 8 illustrates a view of an information management application in an implementation.

### TECHNICAL DISCLOSURE

Implementations disclosed herein facilitate improved information management applications. In at least one implementation, an enhanced calendar view includes an initial range in a series of calendar units. For example, a time strip may be arranged cross the top of a calendar view, along the side, or at the bottom.

An initial calendar perspective associated with an initial position established within the initial range is also presented. In a scenario, the days associated with a selected month are presented within a monthly view of a month. Responsive to a user input, such as a swipe, click, or some other input, a navigation effect is presented with respect to the series of calendar units. The navigation effect may be representative of, for example, navigating from the initial range to a subsequent range in the series of calendar units.

A subsequent perspective associated with a subsequent position established within the subsequent range is then presented. For example, the days associated another month may be presented within a monthly perspective of that month.

In some implementations, the series of calendar units are arranged in a landscape of units, such as a horizontal ribbon or strip in which multiple units are displayed simultaneously. For example, the initial range in the series of calendar units may be represented by multiple months visible in a time strip at the same time. A swipe, click, touch, or some other input may cause a navigation effect with respect to the time strip that gives the appearance of scrolling left or right through the time strip. Thus, a user may navigate from the initial range of months (or other units) in the time strip to a subsequent range.

The landscape of units enables a user to view a range of months, days, or weeks from which to make a selection, rather than having to click through a series of units to reach a desired position. For example, a user may establish an initial position in a range of units, scroll through the range of units, and then establish a subsequent position in the range. This allows a user to jump from one month to another, for example, without having to navigate through any intermediate months.

The scrolling effect that may be presented in some implementations with respect to a time strip brings calendar units into and out of view as the time strip is shifted to the left or right. For example, an initial range of units may include the months of April through July arranged from left to right. Advancing through the time strip to October would shift at least April and possibly other months out of view. Moving backward through the time strip to January would shift at least July and possibly other months out of view.

In various scenarios a drag-and-drop feature may be included that enables a user to drag an unseen month or other unit into view. Upon releasing or dropping the time strip, the calendar perspective is populated with the days of the month or other unit. In an example, an initial range presented in a time strip may include the months of April through July with an initial position established in the range on May. Accordingly, the calendar perspective displays the days of the month in May. A user may touch the time strip and drag it to the right two notches such that the month of February comes into view on the time strip. Releasing the time strip then causes the days of the month displayed in the calendar perspective to immediate change from those in May to those in February.

Referring now to the drawings, FIG. 1 illustrates a view of an information management application and an associated operational scenario reflective of an enhanced view process illustrated in FIG. 2. FIG. 3 illustrates a computing architecture suitable for any computing system or systems that may employ the enhanced view process of FIG. 2. FIG. 4 illustrates a communication environment in which an information management application and associated services may be deployed. FIGS. 5-8 illustrate various views and associated operational scenarios related to various features and functionality that may be provided by an information management application in some implementations.

Turning to FIG. 1, an enhanced view 100 of an information management application is illustrated in an implementation. FIG. 1 also illustrates an operational scenario that may occur when the information management application implements or is otherwise subject to enhanced view process 200 illustrated in FIG. 2. The following discussion of FIG. 1 therefore makes parenthetical reference to the various steps included in enhanced view process 200.

Initially, enhanced calendar view 100 is presented, including an initial range in a series of calendar units (step 201). Enhanced calendar view 100 includes information bar 101, calendar module 103, monthly perspective 105, and time strip 107. Time strip 107 includes the initial range in the series of calendar units. The information management application, of which enhanced calendar view 100 provides one representation, may be any application or collection of applications, module or collection of modules, service or services, or any variation or combination thereof capable of providing information management services and functionality. Examples of the information management application include Microsoft® Outlook®, Outlook® Web App, Mobile Outlook®, Hotmail®, Outlook.com, and Gmail, as well as any other information management application.

The information management application may include one or more information modules, of which calendar module 103 is representative. Calendar module 103 may be any component or other aspect of the information management application with which a user interacts to gain access to at least some of the various calendaring functions and services provided by the information management application, such as the ability to schedule events, invite others to participate in events, and the like. Other example modules include email modules, task modules, and contact modules, as well as any other type of module, combination, or variation thereof.

In operation, a unit is selected from time bar 107. In this implementation the units are months, although it may be appreciated that other units are possible, such as days and weeks. Accordingly, monthly perspective 105 is presented (step 203) that includes a grid and various days associated with the selected month (January, 2013).

A user may navigate through the series presented in time bar 107 by way of some user input, such as a swipe 109. This results in a navigating effect, such as a scroll or some other graphical representation of navigating through the series (step 205). A new or subsequent position may be established in the range, which has shifted, and a subsequent perspective presented accordingly (step 207). For example, the new position may be a new month (October, 2014) and the updated perspective may include the days for that month.

It may be appreciated that while the discussion of enhanced view process 200 illustrated in FIG. 2 generally refers to specific steps, such as presenting a range, presenting a perspective, presenting a navigating effect, and presenting a subsequent perspective, variations of the process are possible and may be considered within the scope of the present disclosure. Taking the step of initiating any of the aforementioned steps, as opposed to fully carrying them out, may be considered a variation. Thus, initiating presentation of a range, a navigating effect, or a subsequent perspective may be considered a variation on the specific steps illustrated in FIG. 2.

The term presenting as used herein generally refers to the various capabilities employed in various computing architectures to assemble information that can then be used by other capabilities to generate an image or images. Within the context of enhanced view process 200, for example, presenting an enhanced calendar view or making any modifications thereof may generally refer to assembling the information or data used to generate an image or images that together result in those features. Other types of output in addition to images are also possible, such as voice readouts, touch-based output, and sounds.

However, it may be appreciated that other perspectives on presenting may be considered within the scope of the present disclosure. For example, presenting as used herein may also, in some scenarios, be considered to refer to the various capabilities employed by various computing architectures to generate an image or images from information assembled for that purpose. With respect to enhanced view process 200, presenting an enhanced view or making a modification to it, or an effect with respect to it, may refer to generating an image or images, from information assembled for that purpose, that together result in those features.

It may also be appreciated that presenting in some scenarios may refer to a combination of the aforementioned possibilities. For example, presenting in some scenarios may refer to both assembling the information used to generate an image or images for a feature and then generating the image or images for the feature. In addition, a wide variety of other steps, processes, and stages may occur within the context of presenting features of an application, such as driving the display of, or even actually displaying, images or other representations of a feature, all of which may be considered part of presenting a feature.

Referring now to FIG. 3, computing architecture 300 is representative of an architecture that may be employed in any apparatus, system, or device, or collections thereof, to suitably implement all or portions of enhanced view process 200 illustrated in FIG. 2 or variations thereof and optionally all or portions of the information management application referred to with respect to FIG. 1. Enhanced view process 200 may be implemented on a single apparatus, system, or device or may be implemented in a distributed manner. The information management application may also be implemented on a single apparatus, system, or device or may be implemented in a distributed manner. Enhanced view process 200 may be integrated with the information management application, but may also stand alone or be embodied in some other application.

Computing architecture 300 may be employed in, for example, desktop computers, laptop computers, tablet computers, notebook computers, mobile computing devices, cell phones, media devices, and gaming devices, as well as any other type of physical or virtual computing machine and any combination or variation thereof. Computing architecture 300 may also be employed in, for example, server computers, cloud computing platforms, data centers, any physical or virtual computing machine, and any variation or combination thereof.

Computing architecture 300 includes processing system 301, storage system 303, software 305, communication interface system 307, and user interface system 309. Processing system 301 is operatively coupled with storage system 303, communication interface system 307, and user interface system 309. Processing system 301 loads and executes software 305 from storage system 303. When executed by processing system 301, software 305 directs processing system 301 to operate as described herein for enhanced view process 200 or its variations. Computing architecture 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variation.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal.

In addition to storage media, in some implementations storage system 303 may also include communication media over which software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 301 or possibly other systems.

Software 305 may be implemented in program instructions and among other functions may, when executed by processing system 301, direct processing system 301 to operate as described herein for enhanced view process 200 illustrated in FIG. 2. In particular, the program instructions may include various components or modules that cooperate or otherwise interact to carry out enhanced view process 200. The various components or modules may be embodied in compiled or interpreted instructions or in some other variation or combination of instructions. The various components or modules may be executed in a synchronous or asynchronous manner, in serial or in parallel, in a single threaded environment or multi-threaded, or in accordance with any other suitable execution paradigm, variation, or combination thereof. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform a suitable apparatus, system, or device employing computing architecture 300 overall from a general-purpose computing system into a special-purpose computing system customized to facilitate enhanced calendar views as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage, as well as other factors.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing architecture 300 is generally intended to represent an architecture on which software 305 may be deployed and executed in order to implement enhanced view process 200 (or variations thereof) and optionally all or portions of an information management application. However, computing architecture 300 may also be suitable for any computing system on which software 305 may be staged and from where software 305 may be distributed, transported, downloaded, or otherwise provided to yet another computing system for deployment and execution, or yet additional distribution.

Referring again to FIG. 1, through the operation of a suitable computing system employing software 305, transformations may be performed with respect to enhanced calendar view 100. As an example, enhanced calendar view 100 could be considered transformed from one state to another when subject to enhanced view process 200. In a first state, the computing system presents enhanced calendar view 100 with a calendar perspective associated with a first established position in time strip 107. Responsive to some indication of interest with respect to a different position in the range, the calendar perspective may be associated with a new, subsequently selected and established position in the range, thereby changing enhanced calendar view 100 to a second, different state.

Referring again to FIG. 3, communication interface system 307 may include communication connections and devices that allow for communication with other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface system 309 may include a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 309. In some cases, the input and output devices may be combined in a single device, such as a display capable of displaying images and receiving touch gestures. The aforementioned user input and output devices are well known in the art and need not be discussed at length here. User interface system 309 may also include associated user interface software executable by processing system 301 in support of the various user input and output devices discussed above. Separately or in conjunction with each other and other hardware and software elements, the user interface software and devices may support a graphical user interface, a natural user interface, or the like.

FIG. 4 illustrates a communication environment 400 in which various information management applications may be supported to implement enhanced calendar views and their associated operations, such as enhanced calendar view 100 discussed with respect to FIG. 1. Communication environment 400 includes application platform 401, application platform 403, and application platform 405. Application platform 401 and application platform 403 may communicate with service environment 407 to access information exchange service 417 on behalf of information management application 411 and information management application 413 respectively. Application platform 405 may communicate with service environment 409 to access information exchange service 419 on behalf of information management application 415. From time to time, service environment 407 and service environment 409 may communicate in furtherance of interaction between information exchange service 417 and information exchange service 419

Examples of application platforms 401, 403, and 405, include, but are not limited to, desktop computers, work stations, laptop computers, notebook computers, tablet computers, mobile phones, personal digital assistants, media devices, gaming devices, and any other physical or virtual computing machine or combinations and variations thereof capable of implementing at least one of a variety of information management applications. Service environment 407 may be any computing system or collection of computing systems capable of implementing an information exchange service 417.

Application platforms 401, 403, and 405 may each be any computing apparatus, system, device, or collections thereof that employ a computing architecture suitable for implementing information management application 411, 413, or 415 respectively. Computing architecture 300 referred to with respect to FIG. 3 is one such representative architecture. Information management applications 411, 413, and 415 may each be any version or variety of an information management application. Examples include but are not limited to locally installed and executed applications, streaming applications, web-based applications that execute at least in part within the context of a browser application, mobile applications, mobile web-based applications that execute at least in part within the context of a mobile browser application, or any other application type, variation, or combination thereof.

Information management applications 411, 413, and 415 may each be embodied in program instructions that, when executed by application platforms 401, 403, and 415 respectively direct each to operate as described herein for enhanced view process 200 discussed with respect to FIG. 2. The program instructions may take the form of compiled object code, interpreted scripts, or any other suitable form of program instructions that may be executed directly or indirectly by an application platform, as well as any suitable variation or combination thereof. Examples of information management applications include but are not limited to Microsoft® Outlook®, Mozilla Thunderbird/Lightning, Open-Xchange, Microsoft® Outlook® Web App, Microsoft® Outlook® Web App for mobile device, Outlook.com®, Gmail, and Microsoft® Outlook® for mobile devices, as well as another suitable information management application, variation, or combination thereof.

Service environment 407 and service environment 409 may each include any computing apparatus, system, device, or collections thereof that employ a computing architecture suitable for implementing information exchange service 417 and information exchange service 419 respectively. Computing architecture 300 referred to with respect to FIG. 3 is one such representative architecture. Examples include server computers, cloud computing platforms, data centers, and any physical or virtual computing machine, as well as any variation or combination thereof. Examples of information exchange service 417 and information exchange service 419 include but are not limited to Microsoft® Exchange®, Microsoft® Office 365®, Hotmail®, Outlook.com®, and Gmail, as well as any other information exchange service, combination, or variation thereof capable of operating as described herein.

In operation, any of application platforms 401, 403, and 405 may communicate from time to time with service environment 407 or service environment 409 over communication network 410 to facilitate the exchange of information between information management applications 411 and 413 and information exchange service 417 and between information management application 415 and information exchange service 419. Service environment 407 and service environment 409 may also communicate over communication network 410 to facilitate the exchange of information.

Communication between any of the elements contemplated in FIG. 4 may occur in accordance with various communication protocols, such as the Internet protocol (IP, IPv4, IPv6, etc.), the transfer control protocol (TCP), and the user datagram protocol (UDP), as well as any other suitable communication protocol, variation, or combination thereof. Communication network 410 may be representative of a network or collection of networks over which the element contemplated in FIG. 4 may exchange information, such as an intranet, the Internet, a local area network, a wide area network, a wireless network, a wired network, or any combination or variation thereof. Communication link 410 may include connections, devices, and communication media, such as metal, glass, air, or any other suitable communication media over which information may be exchanged. The aforementioned communication media, network, connections, protocols, and devices are well known and need not be discussed at length here.

The manner in which information is exchanged may vary. In some implementations, an application may exchange information with a service environment and information exchange service in accordance with various information exchange protocols, such as IMAP (internet message access protocol), POP (post office protocol), SMTP (simple mail transfer protocol), and MAPI (message application programming interface). In other implementations, an application may exchange information with a service environment and information exchange service in accordance with various other information exchange protocols, such as HTTP (hypertext transfer protocol), REST (representational state transfer), or WebSocket, as well as any other suitable information exchange protocol, variation, or combination thereof.

What information is exchanged or what format the information takes may also vary. For example, an application or associated browser (in the case of a browser based application) may receive information formatted in accordance with a variety of information protocols, such as DOM (Document Object Model), HTML (hypertext markup language), CSS (cascading style sheets), HTML5, XML (extensible markup language), Javascript, JSON (Javascript Object Notation), and AJAX (Asynchronous Javascript and XML), as well as any suitable information protocol, variation, or combination thereof. The information may include data or objects that may be processed for presentation, such as images and text. However, the information may also include scripts or other information that may be interpreted or otherwise processed by the browser or some other application for execution. In other implementations, an application may exchange discrete messages representative of an email, calendar event, or some other item of information formatted in accordance with an information protocol suitable to that application.

FIG. 5 illustrates one exemplary view 501 that may be rendered by one or more of information management applications 411, 413, and 415. In addition, three different scenarios 591, 593, and 595 are illustrated to demonstrate how view 501 may be scaled based on the form factor of a rendering device. In scenario 591, view 501 is rendered in full and may be representative of a view displayed on a relatively large screen, such as a computer monitor or other suitable device. In scenario 593, view 501 is scaled down relative to its presentation in scenario 591, and may be representative of an application scale experienced on a tablet device or some other device having smaller dimensions. In scenario 595, view 501 is scaled down even more relative to scenario 591 and scenario 593 and may be representative of an application scale experience on a mobile phone or other similar devices.

In scenario 591, view 501 includes an information area 511 that may be used to display the name of the application or other suitable information. Information area 511 includes several selectable options that, when selected, launch the presentation of other views associated with other modules. In particular, mail option 512 corresponds to an email module, calendar option 513 corresponds to a calendar module, contacts option 514 corresponds to a contacts module, and tasks option 515 corresponds to a tasks module. Information area 511 also includes an identity option 516 representative of an identity of a user engaged with view 501. View 501 may include additional features or some of the features discussed herein may be omitted.

For exemplary purposes, it is assumed that mail option 512 has been selected and thus view 501 is representative of a view that may be encountered when working with an email module. Accordingly, view 501 includes various panels having various items and other functionality rendered and available for interaction with a user. Navigation panel 521 includes, but is not limited to, various folders that a user may select in order to access their contents, such as an inbox folder 525, a sent folder 527, and a drafts folder 529. Depending upon which folder is selected, its corresponding contents may be displayed in the panel adjacent to navigation panel 521. It is assumed here for exemplary purposes that inbox folder 525 is selected. Accordingly, inbox 531 and its contents are displayed adjacent to navigation panel 521. It may be appreciated that the various panels and their contents could be arranged in a variety of ways and are not limited to just those disclosed herein.

Content panel 539 provides a more detailed view of a selected item. For example, content panel includes content associated with email 536, assumed for exemplary purposes to have been selected by a user for reading, editing, or the like. Other aspects may be included in content panel 539, such as in-line reply capabilities, that are well known and need not be discussed at length here.

In scenario 593, information area 511 is considerably smaller relative to its size in scenario 591. In addition, navigation panel 521 is absent. It may be appreciated that other configurations are possible that would results in a smaller scale for view 501 and may be considered within the scope of the present disclosure. For example, other elements may be absent rather than, or in addition to, navigation panel 521.

In scenario 595, content panel 539 is absent, in addition to navigation panel 521, and thus the scale of view 501 is considerably smaller than in scenario 591 or 593. It may be appreciated that other configurations are possible that would results in a smaller scale and may be considered within the scope of the present disclosure, such as by eliminating other elements in place of or in addition to navigation panel 521 and content panel 539.

FIG. 6 illustrates various scenarios 693, and 695 that again demonstrate how an information management application may scale to fit the display dimensions of a given device. Scenarios 693, and 695 illustrate the same view 501 as in FIG. 5, except that it is assumed here for exemplary purposes that calendar module 513 has been selected. In scenario 693, view 501 may be representative of a view displayed on a variety of screens, such as a computer monitor, tablet device, or the like. In scenario 695, view 501 is scaled down relative to scenario 693 and may be representative of an application scale experience on a mobile phone or other similar devices.

When selected and active, calendar module 513 in scenario 691 includes a calendar panel 545 and a time bar 577. Calendar panel 545 includes a calendar perspective 547 on a month to which a user navigated using time bar 577. Calendar perspective 547 includes a grid and various days within the grid. Time bar 577 includes a series of calendar units, which in this scenario are represented by a series of months. A user may interact with time bar 577 in a manner discussed with respect to FIG. 1 and FIG. 2 to quickly navigate to a different period of time.

Scenario 695 illustrates a scaled down version of view 501. In this scenario, time bar 577 is shortened relative to its presenting in scenario 693. In addition, calendar perspective 547 is slightly compressed relative to its previous presentation.

In scenario 693, calendar perspective 547 associated with an initial position established within the initial range in time bar 577 is presented in view 501. In this scenario, the initial position is established at the month of January in time bar 577. Accordingly, the days associated with the selected month are presented within the monthly perspective of January represented in calendar perspective 547. Responsive to a user input, such as a swipe, click, or some other input, a navigation effect may be presented with respect to the series of calendar units in time bar 577. The navigation effect may be representative of, for example, navigating from the initial range to a subsequent range in the series of calendar units. A subsequent perspective associated with a subsequent position established within the subsequent range is then presented. For example, the days associated another month may be presented within a monthly perspective of that month.

FIG. 7 illustrates another scenario 793 with respect to view 501. In operation, calendar perspective 547 initially reflects the days of the month associated with an active month selected from time bar 577, which in this case are the days of the month for April, 2013. By way of a “drag and drop” or a “drag and release” operation, a user may drag a new month on time bar 477 into view and then release time bar 577 in order to automatically change which days are reflected in calendar perspective 547 to those associated with the month brought into view.

Referring to scenario 793, a user drags time bar 577 to the right such that various months come into view and other are pushed out of view. Such dragging brings some calendar units into view and pushes other calendar units out of view as the time bar 577 is shifted to the left or right. For example, the initial range of units in scenario 793 includes the months of April through October arranged from left to right. Advancing through the time bar 577 to the right shifts October and possibly other months out of view. Releasing the time bar 577 after November comes into view caused the causes the days of the month displayed in the calendar perspective to immediately change from those in April to those in November.

Another feature illustrated in scenario 793 is a symbol positioned between December and January representative of a split between different intervals of time units. In this example, the symbol represents the end of one year and the beginning of a next year. In some scenarios, time bar 577 may be at a different scale and thus the symbol could delineate between intervals at the different scale. For example, a visible symbol may be position between weeks in a time bar scaled to weeks.

FIG. 8 illustrates a view 800 or screen shot representative of an enhanced calendar view presented within the context of an information exchange application, such as enhanced calendar view 100. View 800 includes a monthly perspective on a calendar and a time bar. The time bar may be navigated as discussed above with respect to the various implementations illustrated in the Figures.

The discussion of FIGS. 1-8 for purposes of clarity may have referred to various elements included in information management applications, such as days, calendar perspectives, time bars, panels, and areas, as well as other elements, without referring to those elements as graphical representations of the same or in some other manner indicative of their technical nature. However, it may be appreciated that such terms and phrases may be used interchangeably and such usage or lack thereof does not limit the scope of the present disclosure. To the contrary, the present disclosure may be considered to encompass a wide variety of well-known techniques for graphically representing the various elements included in the various implementations discussed throughout. Thus, at least a portion of these and other elements illustrated in FIGS. 1-8 may be embodied in graphical representations of the elements. For example, a day, perspective, or panel referred to as such with respect to the Figures may be considered a graphical representation of the same.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable storage media having program instructions stored thereon for facilitating an enhanced calendar view that, when executed by a computing system, direct the computing system to at least:
present an initial range in a series of calendar units;
present an initial calendar perspective associated with an initial position established within the initial range;
responsive to a user input, present a navigation effect with respect to the series of calendar units comprising navigating from the initial range to a subsequent range in the series of calendar units; and
present a subsequent calendar perspective associated with a subsequent position established within the subsequent range.

2. The one or more computer readable storage media of claim 1 wherein to present the initial range in the series of calendar units, the program instructions direct the computing system to present a time strip comprising the initial range.

3. The one or more computer readable storage media of claim 2 wherein the program instructions direct the computing system to arrange the time strip above the initial calendar perspective in the enhanced calendar view.

4. The one or more computer readable storage media of claim 3 wherein the series of calendar units comprises a plurality of calendar units in a sequential order.

5. The one or more computer readable storage media of claim 4 wherein the plurality of calendar units comprises a plurality of months and wherein the initial position corresponds to a selected month in the plurality of months.

6. The one or more computer readable storage media of claim 5 wherein the initial calendar perspective comprises a monthly perspective on the selected month.

7. The one or more computer readable storage media of claim 6 wherein the subsequent position corresponds to a subsequently selected month in the plurality of months and wherein the subsequent calendar perspective comprises a subsequent monthly perspective on the subsequently selected month.

8. The one or more computer readable storage media of claim 1 wherein the navigation effect comprises a scrolling effect and wherein the user input comprises a swiping gesture.

9. A method for facilitating an enhanced calendar view comprising:
presenting an initial range in a series of calendar units;
presenting an initial calendar perspective associated with an initial position established within the initial range;
responsive to a user input, presenting a navigation effect with respect to the series of calendar units comprising navigating from the initial range to a subsequent range in the series of calendar units; and
presenting a subsequent calendar perspective associated with a subsequent position established within the subsequent range.

10. The method of claim 9 wherein presenting the initial range in the series of calendar units comprises a time strip having the initial range represented therein.

11. The method of claim 10 further comprising arranging the time strip above the initial calendar perspective in the enhanced calendar view.

12. The method of claim 11 wherein the series of calendar units comprises a plurality of calendar units in a sequential order.

13. The method of claim 12 wherein the plurality of calendar units comprises a plurality of months and wherein the initial position corresponds to a selected month in the plurality of months.

14. The method of claim 13 wherein the initial calendar perspective comprises a monthly perspective on the selected month.

15. The method of claim 14 wherein the subsequent position corresponds to a subsequently selected month in the plurality of months and wherein the subsequent calendar perspective comprises a subsequent monthly perspective on the subsequently selected month.

16. The method of claim 15 wherein the navigation effect comprises a scrolling effect and wherein the user input comprises a swiping gesture.

17. A computing apparatus comprising:
one or more computer readable storage media;
program instructions stored on the one or more computer readable storage media;
a processing system that, when executing the program instructions, is directed by the program instructions to initiate presentation of an initial range in a series of calendar units, initiate presentation of an initial calendar perspective associated with an initial position established within the initial range, and responsive to a user input, initiate presentation of a navigation effect with respect to the series of calendar units comprising scrolling from the initial range to a subsequent range in the series of calendar units.

18. The computing apparatus of claim 17 wherein the processing system is further directed to present a subsequent calendar perspective associated with a subsequent position established within the subsequent range.

19. The computing apparatus of claim 18 wherein the series of calendar units comprises a series of months, wherein the initial position comprises a month, and wherein the initial perspective comprises a monthly perspective on the month.

20. The computing apparatus of claim 17 wherein the user input comprises a dragging gesture.
